(19) United States
(12) Patent Application Publication
(10) Pub. No.: US 2018/0128716 A1
(43) Pub. Date: May 10, 2018

(54) PARTICLE COLLECTING APPARATUS

(71) Applicant: Shimadzu Corporation, Kyoto (JP)

(72) Inventors: Hiroshi Seki, Kyoto (JP); Yoshihiro Ueno, Kyoto (JP); Hiroshi Okuda, Kyoto (JP); Hiromu Sakurai, Ibaraki (JP)

(73) Assignee: Shimadzu Corporation, Kyoto (JP)

(21) Appl. No.: 15/808,377

(22) Filed: Nov. 9, 2017

(30) Foreign Application Priority Data
Nov. 10, 2016 (JP) 2016-219584

(51) Int. Cl. G01N 1/22; B08B 15/00

(52) U.S. Cl. CPC G01N 1/2208; G01N 2001/2223; B08B 15/00

(57) ABSTRACT

Minute particles in a gas generated in a particle generating unit are charged by a charging unit. A concentrating unit concentrates charged particles in an introduced gas, and a collecting unit absorbs and collects the concentrated charged particles on a sample plate by an electrostatic force. In the concentrating unit, the charged particles are concentrated by decreasing a flow rate of a gas (carrier gas) in which particles are dispersed while maintaining the number of introduced charged particles. When the flow rate of the gas decreases, and spatial density of the particles increases, it is possible to efficiently collect charged particles on the small sample plate in the collecting unit, and to shorten a collection time.

### FIELD OF THE INVENTION

The present invention relates to a particle collecting apparatus that collects minute particles in gas on a plate to analyze the minute particles.

### BACKGROUND

A minute liquid or solid particle floating in gas is referred to as an aerosol. Many of pollutants in automobile exhaust gas or smoke discharged from a factory are aerosols. In particular, there is concern about an influence of a so-called nano aerosol whose particle size is smaller than 1 μm on health. As a result, analysis of a size, a shape, a component, etc. of the aerosol is significantly important in a field of environmental measurement/evaluation, etc.

Various analyzers such as an atomic force microscope (AFM), an electron probe X-ray micro-analyzer (EPMA), a transmission electron microscope (TEM), a scanning electron microscope (SEM), time-of-flight secondary ion mass spectrometry (TOF-SIMS), X-ray photoelectron spectroscopy (XPS), a fluorescence microscope, etc. have been used for aerosol analysis. When an aerosol is analyzed using such an analyzer, first, minute particles in the atmosphere to be analyzed needs to be collected on a sample plate. When the minute particles are collected on the sample plate, a gas phase environment in which particle aggregation rarely occurs is considered to be suitable. An aerodynamic collection method using an inertial force of a particle such as an impactor, an electrostatic collection method of collecting a charged particle using an electrostatic force thereof, etc. have been well known as a main method of collecting minute particles on a sample plate under the gas phase environment.

In the aerodynamic collection method, for example, as disclosed in “Collection of aerosol·Structure of inertial impactor”, [online], Atmospheric Material Science Laboratory, Terrestrial Science Department, Faculty of Science, Fukuoka University, [searched on July 14, Heisei 28], Internet <URL: http://www.se.fukuoka-u.ac.jp/geophys/am/instrument/sampli ng.html>, when a direction of a gas flow containing a minute particle injected from a nozzle is rapidly changed, the minute particle moves straight by not being able to follow the bending gas flow due to an inertial force, collides with a sample plate disposed in front thereof in a traveling direction, and adheres to the plate, thereby being collected. A size of the collected minute particle may be adjusted by changing a flow rate of gas, a diameter of the nozzle, etc. Meanwhile, in the electrostatic collection method, for example, as disclosed in “SSPM-100 Suspended particle sampler Electrostatic collection mode”, [online], Shimadzu Corporation, [searched on July 14, Heisei 28], Internet <URL: http://www.an.shimadzu.co.jp/powder/products/06sspm/sample .htm>, a minute particle is charged by an electric field generated from a discharge electrode, and the charged minute particle is absorbed to a sample plate by an electrostatic force. In the electrostatic collection method, it is possible to collect a nanoscale minute particle in addition to a minute particle having a relatively large size which can be collected in the aerodynamic collection method.

However, the above-described conventional collection methods have the following problems.

Even though the aerodynamic collection method is simple, since an inertial force of a particle decreases as a size of the particle decreases, a particle having a small size is difficult to collect. In addition, when the flow rate of the gas is increased to increase the number of collected particles, the gas flow becomes strong, and thus a lower limit of a size of a particle that can be collected using an inertial force increases. For this reason, this collection method is unsuitable for collecting a small particle having a nanoscale particle diameter.

Meanwhile, in the electrostatic collection method, even though a small particle at a nanoscale level can be collected as described above, a collection time becomes considerably long when concentration of target particles is low. For example, when sample minute particles in a liquid are sprayed onto a gas flow and collected using electrospray described in “Electrospray Model 3480”, [online], Tokyo Dylec Corp., [searched on July 14, Heisei 28], Internet <URL: http://www.t-dylec.net/products/pdf/tsi_3480.pdf>, there is a circumstance that concentration of the sample minute particles may not be increased so much to avoid clogging of a electrospray nozzle or a capillary. For this reason, it inevitably takes time to collect minute particles. In addition, even when the flow rate of the gas flow is increased to increase the number of collected particles, since an electrostatic force becomes relatively small when compared to a force received from the gas flow, the number of particles attached to the sample plate does not increase so much. For this reason, as a result, it is difficult to shorten time required for particle collection.

### SUMMARY OF THE INVENTION

The invention has been conceived to solve the above-mentioned problems, and an object of the invention is to provide a particle collecting apparatus capable of collecting particles in a wide particle diameter range including small-sized particles which may not be collected using a conventional aerodynamic collection method on a plate in a short time.

A particle collecting apparatus according to the invention conceived to solve the above-mentioned problems includes

a charging unit that receives a gas containing minute particles to be analyzed and charges the minute particles in the gas,

a concentrating unit that concentrates the charged particles charged by the charging unit in a gas phase state, and

a collecting unit that absorbs the charged particles concentrated by the concentrating unit on a holding body by an electrostatic force.

In a conventional particle collecting apparatus, in general, charged particles are attracted by an electric field immediately after the minute particles are charged by a charging unit and absorbed on a holding body such as a sample plate. On the other hand, in the particle collecting apparatus according to the invention, the concentrating unit is provided between the charging unit and the collecting unit. The concentrating unit concentrates the minute particles in the gas charged by the charging unit in a gas phase state, thereby increasing spatial density of the minute particles. In the collecting unit, similarly to the conventional electrostatic collection method, the minute particles are collected by absorbing the charged particles on the holding body such as a sample plate using an electrostatic force. Since the spatial density of the minute particles (charged particles) in the gas supplied to the collecting unit is high, the same amount of minute particles may be collected in a shorter time than that in a conventional case.

Here, the concentrating unit is configured to obtain a gas flow in which charged particles are concentrated by moving charged particles from a gas flow having a relatively large flow rate into a gas flow having a relatively small flow rate.

Alternatively, the concentrating unit is configured to obtain a gas flow in which charged particles are concentrated by decreasing a flow rate of a gas flow while extracting charged particles in the gas flow.

According to such a configuration, even when the flow rate of the gas introduced from the charging unit to the concentrating unit is large, since a flow rate of a gas mixed with charged particles taken out from the concentrating unit is small, it is possible to suppress the flow rate of the gas flow supplied to the collecting unit. In this way, in the collecting unit, an electrostatic force may be relatively increased when compared to a force received from the gas flow, and the charged particles may be efficiently absorbed onto the holding body.

As a specific aspect of the concentrating unit,

it is possible to include

a flow path formation unit in which a first gas flow containing charged particles and a second gas flow containing charged particles flow in the same direction adjacent to each other, and

an electric field formation unit that forms an electric field in the flow path formation unit to move the charged particles in the first gas flow across the gas flow into the second gas flow,

wherein the second gas flow is supplied to the collecting unit.

In the particle collecting apparatus having this aspect, when the electric field is formed in the flow path formation unit by the electric field formation unit, the charged particle in the first gas flow moves toward the second gas flow by action of the electric field. Meanwhile, a carrier gas such as air corresponding to a main component of the gas flow is not affected by the electric field. For this reason, only the charged particles in the first gas flow moves into the second gas flow, and the amount of charged particles in the second gas flow increases. In this way, the flow rate is small when compared to the total flow rate of the gas introduced to the concentrating unit, and the amount thereof hardly changes when compared to the total amount of the minute particles introduced to the concentrating unit, that is, a gas flow having a small flow rate in which minute particles are concentrated may be supplied to the collecting unit.

In the particle collecting apparatus according to the invention, the charging unit and the concentrating unit may be substantially integrated with each other. For example, in the particle collecting apparatus of the aspect, the charging unit and the concentrating unit maybe substantially integrated with each other by adopting a configuration in which a discharge electrode is disposed in the flow path formation unit and the minute particles are charged by discharging from the discharge electrode, or by adopting a configuration in which gas ions generated by discharging, etc. on the outside are fed into the flow path formation unit and brought into contact with the minute particles, thereby charging the minute particles.

In addition, the particle collecting apparatus according to the invention may introduce atmospheric air containing aerosols such as pollutants, and the apparatus may include a minute particle generator for generating aerosols before the charging unit. For example, the minute particle generator is a spray type particle generator such as an atomizer or an electrospray, an evaporation condensation type particle generator, etc.

According to the particle collecting apparatus according to the invention, it is possible to efficiently collect particles in a wide particle diameter range including significantly small-sized particles at a nanoscale level in a short time when compared to a conventional particle collecting apparatus. In this way, it is possible to improve efficiency of analysis work for minute particles.

### BRIEF DESCRIPTION OF THE DRAWINGS

FIG. 1 is a schematic block diagram of a particle collecting apparatus according to a first embodiment of the invention;

FIG. 2 is a schematic configuration diagram of an example of a concentrating unit in the particle collecting apparatus of the first embodiment;

FIG. 3 is a schematic configuration diagram of another example of the concentrating unit in the particle collecting apparatus of the first embodiment;

FIG. 4 is a schematic block diagram of a particle collecting apparatus according to a second embodiment of the invention;

FIGS. 5A and 5B are schematic configuration diagrams of an example of a charging unit and a concentrating unit in the particle collecting apparatus of the second embodiment;

FIG. 6 is a perspective view of a filter in FIG. 5;

FIG. 7 is a plan view of another example of the filter in FIG. 5; and

FIG. 8 is a schematic configuration diagram of another example of the charging unit and the concentrating unit in the particle collecting apparatus of the second embodiment.

### DETAILED DESCRIPTION OF THE INVENTION

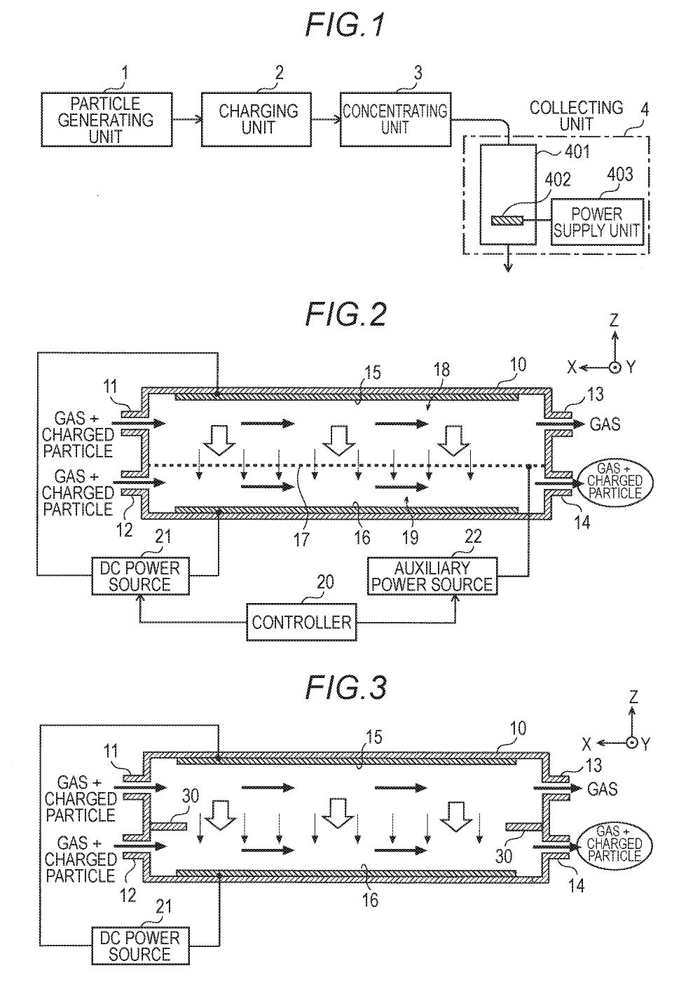

A description will be given of a particle collecting apparatus corresponding to a first embodiment of the invention with reference to FIG. 1 to FIG. 3. FIG. 1 is a schematic block diagram of the particle collecting apparatus of the present embodiment, and each of FIG. 2 and FIG. 3 is a schematic configuration diagram of an example of a concentrating unit in the particle collecting apparatus of the first embodiment.

For convenience of description, front and back, up and down, and right and left are defined by setting an X direction to a left direction, a Y direction to a front direction, and a Z direction to an up direction in FIG. 2. This definition is applied to FIG. 3 and figures described below.

As illustrated in FIG. 1, the particle collecting apparatus of the first embodiment includes a particle generating unit 1, a charging unit 2, a concentrating unit 3, and a collecting unit 4.

For example, the particle generating unit 1 is an electrospray type aerosol generator, and generates minute particles to be analyzed in a gas phase. The particle generating unit 1 may correspond to an aerosol generator of another type, or may be replaced with a sample introducing unit for introducing previously sampled atmospheric air including aerosols. A gas flow containing minute particles to be analyzed is supplied from the particle generating unit 1 to the charging unit 2. In this instance, a carrier gas used for carrying the minute particles corresponds to atmospheric air, synthetic air, nitrogen gas, etc.

The charging unit 2 charges minute particles in introduced gas using various discharges such as corona discharge, arc discharge, spark discharge, dielectric barrier discharge, atmospheric pressure glow discharge, etc. or using a radioisotope such as ²⁴¹Am, ²¹⁰Po, ⁸⁵Kr, etc., and supplies gas containing charged particles to the concentrating unit 3. The concentrating unit 3 decreases a flow rate of gas (carrier gas) in which the particles are dispersed while the number of charged particles in the introduced gas is maintained, thereby supplying the gas in which the charged particles are concentrated to the collecting unit 4. The collecting unit 4 includes a container 401 through which the introduced gas flows, a sample plate installed in the container 401, and a power supply unit 403 that applies a direct current (DC) potential having an opposite polarity to that of charges of the charged particles to the sample plate 402, and attracts the charged particles in the introduced gas using an electrostatic force on a surface of the sample plate 402.

As the flow rate of the gas flow introduced into the collecting unit 4 increases, dispersion of the charged particles increases. Therefore, a large sample plate is required. On the other hand, in this particle collecting apparatus, the flow rate of the gas is decreased while maintaining the number of charged particles in the concentrating unit 3. Therefore, a sample plate having a relatively small size may be used, the number of particles attached per unit area of the surface of the sample plate increases, and an increase rate thereof is fast. In this way, it is possible to collect a sufficient amount of minute particles while shortening a collection time.

FIG. 2 is an example of the concentrating unit 3. The concentrating unit 3 has a substantially parallelepiped casing 10. A first gas introduction port 11 and a second gas introduction port 12 for receiving the gas flow from the charging unit 2 are disposed side by side in a vertical direction on a left side surface of the casing 10. In addition, a discharge port 13 for discharging gas from the casing 10 to the outside and a gas delivery port 14 for feeding gas containing the charged particles to the collecting unit 4 are disposed side by side in the vertical direction on a right side surface of the casing 10. The first gas introduction port 11 and the discharge port 13 are arranged on a substantially straight line, and the second gas introduction port 12 and the gas delivery port 14 are arranged on a substantially straight line.

A first electrode plate 15 is provided on an upper surface and a second electrode plate 16 is provided on a lower surface on the inside of the casing 10. In addition, a filter 17 corresponding to a flat mesh-shaped electrode is disposed between the first electrode plate 15 and the second electrode plate 16 to be substantially parallel thereto. Hereinafter, a space between the first electrode plate 15 and the filter 17 is referred to as a first space 18, and a space between the filter 17 and the second electrode plate 16 is referred to as a second space 19. A DC power supply 21 applies a DC voltage U1 to the first electrode plate 15 and a DC voltage U2 to the second electrode plate 16, an auxiliary power source 22 applies a predetermined DC voltage U3 to an electrode included in the filter 17, and both of the power supplies are controlled by a controller 20.

The carrier gas containing the charged particles delivered from the charging unit 2 is introduced into the casing 10 through the first gas introduction port 11 and the second gas introduction port 12. A flow rate of the carrier gas introduced from the second gas introduction port 12 is lower than a flow rate of the carrier gas introduced from the first gas introduction port 11. The filter 17 having a lattice shape has a large number of openings. However, since the most space inside the casing 10 is partitioned into the first space 18 and the second space 19 by the filter 17, the carrier gas introduced through the first gas introduction port 11 flows from the left to the right in the first space 18 and flows out to the outside from the discharge port 13. Meanwhile, the carrier gas introduced through the second gas introduction port 12 flows from the left to the right in the second space 19 and is sent to the collecting unit 4 through the gas delivery port 14. That is, the gas flow flowing through the first space 18 and the gas flow flowing through the second space 19 are substantially in the same direction and substantially parallel to each other.

While the filter 17 has a function of roughly partitioning the space inside the casing 10, since the predetermined DC voltage U3 is applied to the filter 17, the filter 17 has a function of separating an electric field in the first space and an electric field in the second space from each other. In more detail, for example, when U1>U3>U2, a potential difference of U1−U3 is generated between the first electrode plate 15 and the filter 17, that is, in the first space 18, and a DC electric field is formed by this potential difference. Meanwhile, a potential difference of U3−U2 is generated between the filter 17 and the second electrode plate 16, that is, in the second space 19, and a DC electric field is formed by this potential difference. The DC voltage U3 is appropriately set such that the potential difference in the first space 18 is larger than the potential difference in the second space 19. As a result, the DC electric field in the first space 18 becomes stronger than the DC electric field in the second space 19.

These DC electric fields are DC electric fields having a potential gradient which is a downward slope for the charged particles in a direction indicated by thick outlined arrows of FIG. 2. Due to action of these electric fields, the charged particles in the carrier gas flowing in the first space 18 receives a downward force and enters the second space 19 through the openings of the filter 17 as indicated by downward thin arrows of FIG. 2. Meanwhile, neutral gas molecules move straight without being influenced by the electric fields. Since the DC electric field in the second space 19 is relatively weak, the force acting on the charged particles after entering the second space 19 is small. For this reason, the charged particles arriving at the second space 19 moves along the carrier gas directed from the second gas introduction port 12 to the gas delivery port 14. The carrier gas originally contains charged particles, and charged particles moved from the first space 18 due to the action of the electric fields as described above are added thereto. Thus, the number of charged particles increases. As a result, the carrier gas in which the charged particles are concentrated is delivered from the gas delivery port 14. Meanwhile, since the charged particles are deprived, the carrier gas containing few charged particles is discharged from the discharge port 13 to the outside.

As described above, in the concentrating unit 3, a carrier gas containing concentrated charged particles and having a small flow rate maybe sent out through the gas delivery port 14.

Instead of using the mesh-shape electrode as the filter 17, it is possible to use a plurality of rod-shaped electrodes described below which are disposed in parallel.

In the concentrating unit 3, the filter 17 that vertically partitions the inside of the casing 10 is not an essential component. As illustrated in FIG. 3, it is possible to adopt a configuration in which the filter 17 is not provided. Here, a current plate 30 is provided such that a gas flow from the first gas introduction port 11 to the discharge port 13 and a gas flow from the second gas introduction port 12 to the gas delivery port 14 easily move straight.

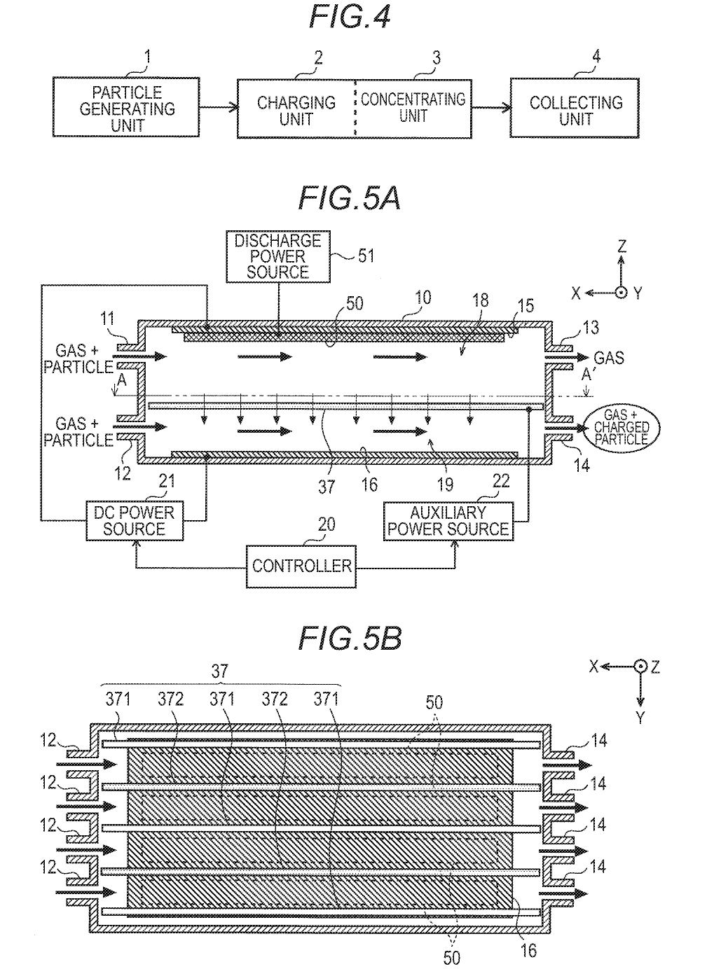

Next, a description will be given of a particle collecting apparatus corresponding to a second embodiment of the invention with reference to FIG. 4 to FIG. 8. FIG. 4 is a schematic block diagram of the particle collecting apparatus corresponding to the second embodiment.

As illustrated in FIG. 4, in the particle collecting apparatus of the second embodiment, a charging unit 2 and a concentrating unit 3 are substantially integrated with each other. Further, gas containing minute particles is received to charge particles in a gas phase state, and the charged particles immediately after charging are concentrated and delivered to a collecting unit 4.

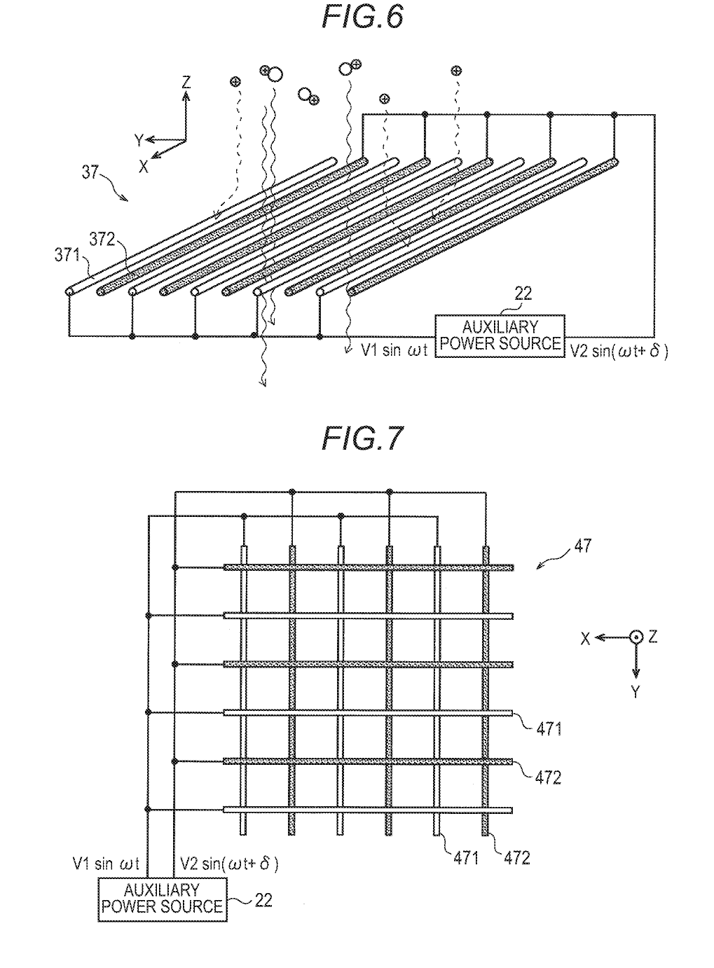

FIG. 5A is a schematic configuration diagram of the charging unit 2/the concentrating unit 3 in the particle collecting apparatus of the second embodiment, and FIG. 5B is a cross-sectional view taken along A-A′ line of FIG. 5A. FIG. 6 is a perspective view of a filter 37 of the charging unit 2/the concentrating unit 3 illustrated in FIG. 5A.

In the charging unit 2/the concentrating unit 3, a carrier gas containing minute particles that are not charged is supplied into a casing 10 through a first gas introduction port 11 and a second gas introduction port 12, the minute particles are charged in a first space 18, and the charged particles moves to a second space 19 by action of an electric field. To charge the minute particles in the first space 18, discharge elements 50 corresponding to a plurality of surface-discharge microplasma devices, etc. are disposed below a first electrode plate 15, and a high voltage is applied to each of the discharge elements 50 from a discharge power source 51.

As illustrated in FIG. 6, the filter 37 includes a plurality of rod-shaped electrodes 371 and 372 disposed on one surface in parallel to each other at a predetermined interval. The rod-shaped electrodes correspond to a pair of electrodes in which a plurality of rod-shaped electrodes (371 or 372) corresponding to every other rod-shaped electrode in the Y direction is set to a set, and alternating current (AC) voltages V1sinωt and V2sin (ωt+δ) having the same frequency and different phases are applied from an auxiliary power source 22 to one set of the plurality of rod-shaped electrodes 371 and the other set of the plurality of rod-shaped electrodes 372, respectively. A phase difference δ may be appropriately determined and normally corresponds to a value in a range of 90° to 270°. In addition, amplitudes V1 and V2 of the AC voltages are appropriately determined. Not only the AC voltages but also appropriate DC voltages may be applied to the filter 37 as in the above example.

When a predetermined voltage is applied from the discharge power source 51 to the discharge element 50, and discharge occurs in the discharge element 50, gas molecules in the carrier gas are ionized, and gas ions are generated. When the minute particles in the carrier gas come into contact with the gas ions, the minute particles are charged. A force resulting from the DC electric field generated in the first space 18 acts on the generated charged particles, and thus the charged particles move downward. As described above, in the filter 37 that separates the first space 18 and the second space 19 from each other, AC voltages having different phases are applied to adjacent rod-shaped electrodes 371 and 372. For this reason, as described above, charged particles traveling downward in the casing 10 and passing between the rod-shaped electrodes 371 and 372 receive an attractive force and a repulsive force from the right and left rod-shaped electrodes 371 and 372. An object having relatively high mobility is rapidly attracted to one of the rod-shaped electrodes 371 or 372 to collide with the electrode, and thus may not pass through a space (opening) between the both rod-shaped electrodes. On the other hand, an object having relatively low mobility is attracted in an opposite direction by an attractive force from one of the rod-shaped electrodes 371 and 372 before colliding with the other rod-shaped electrode, and thus passes between the rod-shaped electrodes 371 and 372 while stably vibrating in a left-right direction.

Meanwhile, a gas ion generated by discharge has remarkably small mass than that of the charged particle, and thus has high mobility. For this reason, it is possible to allow only the charged particle to pass through the filter 37 and the gas ion to collide with the filter 37 by appropriately adjusting conditions (amplitude, a frequency, and a phase difference) of the voltages applied from the auxiliary power source 22 to the rod-shaped electrodes 371 and 372. As a result, only the charged particle having relatively lower mobility than that of the gas ion moves from the first space 18 to the second space 19. When a large amount of gas ions flow into the second space 19, the charged particles come into contact with the gas ions again, and thus multivalent charging is likely to occur. On the other hand, in this configuration, it is possible to inhibit the gas ions from flowing into the second space 19, and to inhibit the charged particles from further coming into contact with the gas ions, thereby suppressing multivalent charging. In this way, it is possible to increase the proportion of monovalently charged particles in charged particles taken out from the gas delivery port 14.

The filter 37 may not be a filter in which the rod-shaped electrodes 371 and 372 are arranged as described above. As described in FIG. 7, it is possible to adopt a configuration in which a plurality of thin wire electrodes 471 and 472 is arranged in a lattice shape, that is, a configuration having a mesh shape in a planar view. In this filter 47, an electrode group including wire electrodes 471 and 472 arranged in a vertical direction (Y direction) and an electrode group including wire electrodes 471 and 472 arranged in a horizontal direction (X direction) are disposed to be separated from each other in a direction (Z direction) of action resulting from an electric field formed by the first electrode plate 15 and a second electrode plate 16. Further, AC voltages V1sinωt and V2sin (ωt+δ) having the same frequency and different phases are applied to adjacent electrodes 471 and 472. Therefore, a basic operation is the same as that of the filter 37 described above, and it is possible to block passage of gas ions having high mobility and allow only charged particles having low mobility to pass.

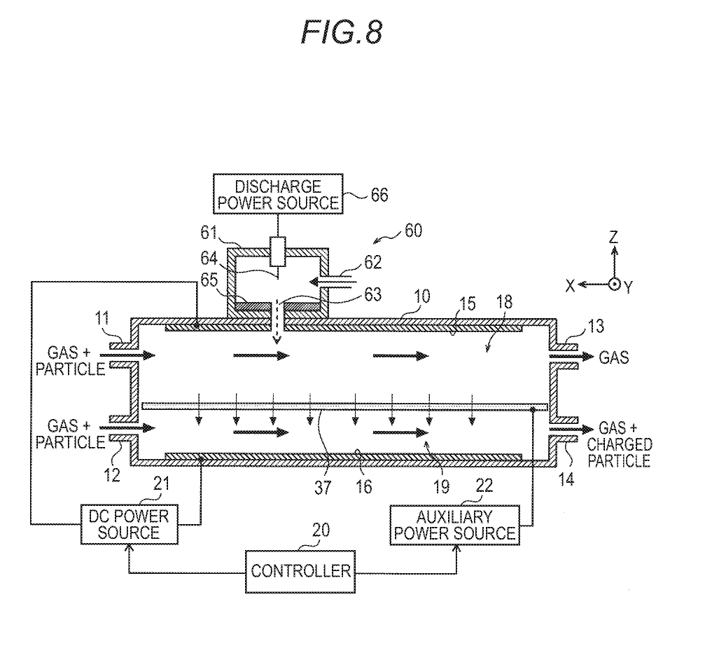

The monovalently charged particles may be mainly taken out from the gas delivery port 14 by providing the filter 37 as described above. In a case in which charged particles in gas introduced into the collecting unit 4 are merely absorbed and collected on a surface of the sample plate 402 by an electrostatic force, there is no problem when the particles are multivalently charged. Therefore, in the concentrating unit 3 in the particle collecting apparatus of the second embodiment, the filter 37 provided inside the casing 10 is not an essential component, and it is possible to adopt a configuration in which the filter 37 and the auxiliary power source 22 applying a voltage thereto are not provided. This description is applied to a configuration illustrated in FIG. 8 described below.

In the charging unit 2/the concentrating unit 3 illustrated in FIG. 5, the gas ions are generated in the first space 18. However, gas ions maybe generated outside the casing 10 and supplied to the first space 18. In a modified example illustrated in FIG. 8, a gas ion generator 60 is provided above the casing 10, and gas ions generated by the gas ion generator 60 are introduced into the casing 10.

The gas ion generator 60 has a substantially rectangular parallelepiped chamber 61. A gas introduction port 62 for introducing a gas ion generation gas into the chamber 61 is provided on side surface of the chamber 61, and an opening 63 for allowing gas ions generated in the chamber 61 to flow out into the first space 18 is formed on a lower surface of the chamber 61. A needle-shaped discharge electrode 64 vertically extending downward from the upper surface is provided in an inner space of the chamber 61, and a flat plate-shaped ground electrode 65, which forms a pair with the discharge electrode 64, is provided at an inner bottom portion of the chamber 61. Corona discharge occurs when a predetermined voltage is applied to the discharge electrode 64 from a discharge power source 66 disposed outside the chamber 61, and gas introduced through the gas introduction port 62 is ionized. The generated gas ions are supplied into the first space 18 through the opening 63 and come into contact with particles in the first space 18 to charge the particles.

In the particle collecting apparatus of the above embodiment, the concentrating unit 3 concentrates the charged particles by moving the charged particles using the action of the electric field. However, for example, the concentrating unit may concentrate the charged particles while reducing the flow rate of the gas flow using an aerodynamic lens disclosed in JP-A-2001-208673. In the aerodynamic lens, a plurality of plates having openings formed at centers thereof are erected inside a cylindrical container, and gas containing charged particles is passed through the central openings so as to be squeezed step by step. For example, when gas in a peripheral portion in which there is no charged particle is gradually discharged each time a gas flow passes through each plate of the aerodynamic lens, it is possible to concentrate the charged particles while decreasing the flow rate of the gas flow.

In addition, the above-described embodiments are merely examples of the invention. Further, it is obvious that even when modification, change, addition, etc. are made within the scope of the spirit of the invention, the modification, change, addition, etc. are encompassed within the scope of the claims of this application.

What is claimed is:

1. A particle collecting apparatus comprising:
a charging unit that receives a gas containing minute particles to be analyzed and charges the minute particles in the gas;
a concentrating unit that concentrates the charged particles charged by the charging unit in a gas phase state; and
a collecting unit that absorbs the charged particles concentrated by the concentrating unit on a holding body by an electrostatic force.

2. The particle collecting apparatus according to claim 1, wherein the concentrating unit obtains a gas flow in which charged particles are concentrated by moving charged particles from a gas flow having a relatively large flow rate into a gas flow having a relatively small flow rate.

3. The particle collecting apparatus according to claim 1, wherein the concentrating unit obtains a gas flow in which charged particles are concentrated by decreasing a flow rate of a gas flow while extracting charged particles in the gas flow.
